(19) United States
(12) Patent Application Publication
(10) Pub. No.: US 2026/0004183 A1
(43) Pub. Date: Jan. 1, 2026

(54) MACHINE-LEARNING MODEL TUNING BASED ON SYSTEM PERFORMANCE METRICS OF DEPLOYMENT SYSTEMS

(71) Applicant: ADVANCED MICRO DEVICES, INC., Santa Clara, CA (US)

(72) Inventor: Harris Gasparakis, Concord, NH (US)

(21) Appl. No.: 18/758,733

(22) Filed: Jun. 28, 2024

(51) Int. Cl. G06N 20/00

(52) U.S. Cl. CPC G06N 20/00

(57) ABSTRACT

To tune a machine-learning model for a deployment system, a machine-learning model training system generates multiple tuning steps for the machine-learning model and generates an accuracy loss sensitivity for each tuning step. Each of the tuning steps indicate a corresponding set of one or more parameters and hyperparameters that reduces the impact of the machine-learning model on the system performance of the deployment system. Based on the accuracy loss sensitivities, the machine-learning model training system selects a tuning step with the least impact on the accuracy of the machine-learning model and modifies the machine-learning model based on the selected tuning step. After also modifying the tuned machine-learning model based on a threshold accuracy, the machine-learning model training system provides the tuned machine-learning model to the deployment system.

### BACKGROUND

To deploy trained machine-learning models on user devices such as desktop computers, laptop computers, mobile devices, and the like, processing systems often include one or more servers each configured to train and distribute the machine-learning models. To this end, these servers first train the machine-learning model using a corresponding set of training data that includes data representing the patterns, relations, and structures that dictate the behavior of the machine-learning model. The servers then modify the trained machine-learning model to increase its accuracy by using a set of reference data that includes inputs and corresponding desired outputs for the trained machine-learning model. As an example, using a loss function derived from the reference data, the servers determine parameters of the trained machine-learning model to modify so as to increase the accuracy of the trained machine-learning model. After improving the accuracy of the trained machine-learning model, the servers transmit the trained machine-learning to a corresponding user device.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a machine-learning model tuning system configured to distribute and modify a trained machine-learning model based on system performance metrics of a deployment system, in accordance with some implementations.

FIG. 2 is a flow diagram of an example operation for modifying a trained machine-learning model based on system performance metrics of a deployment system, in accordance with some implementations.

FIG. 3 is a block diagram of an example deployment system configured to implement a trained machine-learning model modified based on system performance metrics of a deployment system, in accordance with some implementations.

FIG. 4 is a flow diagram of an example method for modifying a trained machine-learning model based on performance data from a deployment system, in accordance with some implementations.

FIG. 5 is a flow diagram of an example method for modifying a trained machine-learning model based on system performance metrics of a deployment system, in accordance with some implementations.

### DETAILED DESCRIPTION

System and techniques disclosed herein are directed toward a processing system configured to modify trained machine-learning models based on one or more system performance metrics and to distribute the modified machine-learning models to one or more deployment systems. To this end, a processing system, also referred to herein as a “machine-learning model tuning system,” includes a model creation system configured to generate, train, and modify one or more machine-learning models. As an example, a model creation system includes one or more servers, computers, processors, programmable logic devices, and the like configured to train a machine-learning model using a corresponding set of training data. A machine-learning model includes one or more supervised learning models, semi-supervised learning models, unsupervised learning models, reinforcement learning models, or any combination thereof. As an example, a machine-learning model includes, but is not limited to, a Naïve Bayes Classifier model, K-means clustering model, support vector machine model, linear regression model, logistic regression model, artificial neural network, convolutional neural network, recurrent neural network, deep-learning model, large language model, and the like.

After training a machine-learning model, the model creation system modifies the machine-learning model so as to improve the accuracy of the trained machine-learning model. Namely, the model tuning system first determines an accuracy loss function based on reference data (e.g., ground truth data) representing respective inputs to a machine-learning model and corresponding reference outputs (e.g., desired outputs) for the trained machine-learning model. As an example, based on the reference data, the model creation system generates an accuracy loss function indicating an accuracy loss value as a function of one or more machine-learning model parameters, hyperparameters, or both. These machine-learning parameters represent the weights and coefficients used by a machine-learning model to determine an output based on one or more inputs and the hyperparameters represent one or more features of the machine-learning model such as data formats used (e.g., single-precision floating point format, double-precision floating point format), matrix dimensions for matrix multiplication, sparsity of matrices, dimensions of feature spaces, numbers of branches, learning rates, numbers of layers, numbers of nodes per layer, numbers of connections between layers, epochs, and the like. Further, the accuracy loss value represents a degree of difference between an output (e.g., predicted output) generated by the trained machine-learning model from an input and a reference output associated with the same input from the reference data. Using the accuracy loss function, the model creation system determines a set of machine-learning parameters, hyperparameters, or both that causes the accuracy loss value to be equal to or less than a predetermined threshold (e.g., an accuracy threshold). That is to say, the model creation system determines a set of machine-learning parameters, hyperparameters, or both that causes the accuracy of the trained machine-learning model to be equal to or above a predetermined accuracy threshold by reducing the accuracy loss value of the accuracy loss function. The model creation system then modifies the trained machine-learning model based on the determined set of machine-learning parameters, hyperparameters, or both.

Once the model creation system has modified the machine-learning model so as to improve its accuracy, the model creation system next modifies the trained machine-learning model so as to reduce the impact of the trained machine-learning model on one or more system performance metrics (e.g., power consumed, processing time, processing efficiency) of a corresponding deployment system (e.g., the deployment system to which the machine-learning model is to be distributed). For example, some trained machine-learning models, such as those trained for high precision arithmetic, use hyperparameters that include certain data types (e.g., floating point (FP) 32, FP64) that allow for high levels of dynamic range and resolution. To help decrease the impact of these machine-learning models on one or more system performance metrics of a corresponding deployment system, the model creation system reduces the bandwidth of these data types within the machine-learning model by changing the data types to FP16, FP8, integer (INT) 8, INT 4, or the like. As another example, to help decrease the impact of a machine-learning model that includes matrix multiplication operations on one or more system performance metrics of a corresponding deployment system, the model creation system is configured to modify one or more hyperparameters to reduce the number channels of the deployment system used to perform such matrix multiplication operations, the convolution filter size, or both. As yet another example, to help decrease the impact of large language model (LLM) on one or more system performance metrics of a corresponding deployment system, the model creation system is configured to modify one or more hyperparameters to change the scarcity of matrices used in operations, the size of matrices used in operations, or both.

However, because a first deployment system is likely to include hardware that is different from the hardware of a second deployment system, tuning a machine-learning model based on the hardware of a first system is likely not to change the impact of the machine-learning model on one or more system performance metrics of the second deployment system. For example, based on the hardware of a second deployment system lacking higher throughput for INT8 data types, tuning the machine-learning model to include INT8 data types will not decrease the impact of the machine-learning model on one or more system performance metrics of the second deployment system. Additionally, because a first deployment system is likely to include hardware that is different from the hardware of a second deployment system, the model creation system is likely able to further or differently tune the machine-learning model based on the hardware of the second deployment system to further reduce the impact of the machine-learning model on one or more system performance metrics of the second deployment system.

As such, to reduce the impact of the machine-learning model on one or more system performance metrics of a corresponding deployment system, for example, the model creation system modifies the trained machine-learning model so as to reduce the impact of the trained machine-learning model on the power needed to generate an output using the trained machine-learning model by a deployment system, the time needed to generate the output using the trained machine-learning model by the deployment system, or both. To this end, along with the accuracy loss function, the model creation system also determines one or more tuning loss functions each indicating an impact of the trained machine-learning model on a corresponding system performance metric of a deployment system. For example, the model creation system generates a computation power loss function indicating a value (e.g., power loss value) representing the power consumed by a deployment system when generating an output using the machine-learning model as a function of one or more machine-learning parameters, hyperparameters, or both. Additionally, for example, the model creation system determines an execution time loss function indicating a value (e.g., time loss value) representing the time needed by the deployment system to generate an output using the machine-learning model as a function of the machine-learning parameters, hyperparameters, or both.

The model creation system is configured to generate these tuning loss functions based on performance data of the deployment system that will be implementing the machine-learning model (e.g., the deployment system to which the modified machine-learning model will be distributed). This performance data, for example, includes data indicating the power consumed, time taken, or both by a respective processing system to generate an output using the machine-learning model with a certain set of machine-learning parameters. To obtain such performance data, as an example, the model creation system is configured to query a database storing performance data for one or more machine-learning models and one or more corresponding deployment systems (e.g., deployment systems on which a respective machine-learning model has been implemented). As another example, to obtain the performance data, the model creation system performs one or more simulation operations that represent a respective deployment system implementing at least a portion (e.g., one or more pipelines, one or more subgraphs) of the machine-learning model to determine an output. The model creation system is configured to perform these simulation operations based on, for example, hardware capability data of a respective deployment system that represents the amount of memory, number of processors, number of processor cores, number of compute units, clock frequencies, number of caches, bus speeds, cache sizes, and the like of the deployment system. As yet another example, to obtain the performance data, the model creation system is configured to provide data representing at least a portion (e.g., one or more pipelines, one or more subgraphs) of the trained machine-learning model to a corresponding deployment system. The deployment system then performs this portion of the trained machine-learning model to generate performance data and transmits this performance data back to the model creation system.

Based on the determined loss function and tuning loss functions, the model creation system then generates a total loss function that indicates a total loss of a machine-learning model as a function of one or more machine-learning parameters, hyperparameters, or both. For example, the model creation system is configured to multiply the loss function, a computation power loss function, and an execution time loss function each by a corresponding weight and aggregate the weighted loss function, computation power loss function, and execution time loss function together to generate the total loss function. Using the total loss function, the model creation system then determines one or more tuning steps that reduce the impact the trained machine-learning model has on one or more system performance metrics of the deployment system. Each tuning step, for example, includes a set of machine-learning parameters, hyperparameters, or both that reduce the impact the trained machine-learning model has on one or more system performance metrics of the deployment system. As an example, one or more tuning steps include a corresponding set of machine-learning parameters, hyperparameters, or both that reduce the power needed to generate an output using the trained machine-learning model by the deployment system, the time needed to generate the output using the trained machine-learning model by the deployment system, or both. For each determined tuning step, the model creation system then determines an accuracy loss sensitivity based on the accuracy loss function. As an example, the model creation system takes a derivative of the accuracy loss function to produce an accuracy loss sensitivity function that indicates accuracy loss sensitivity as a function of one or more machine-learning parameters, hyperparameters, or both. Using the accuracy loss sensitivity function, the model creation system then determines a corresponding accuracy loss sensitivity for each determined tuning step. An accuracy loss sensitivity, for example, includes a value indicating a rate of change for the accuracy loss of the accuracy loss function.

The model creation system then modifies the machine-learning model based on the corresponding accuracy loss sensitivities. As an example, the model creation system first selects the tuning step having a corresponding accuracy loss sensitivity indicating the lowest sensitivity (e.g., lowest rate of change). The model creation system then modifies the machine-learning model based on the set of machine-learning parameters, hyperparameters, or both indicated by the selected tuning step. For example, the model creation system sets one or more machine-learning parameters, hyperparameters, or both of the machine-learning model to be equal to the machine-learning parameters and hyperparameters of the selected tuning step. As another example, the model creation system first determines one or more tuning steps having corresponding accuracy loss sensitives equal to or less than a predetermined accuracy loss sensitivity threshold. From these one or more tuning steps, the model creation system then determines which tuning step indicates a hyperparameter closest in value to a predetermined hyperparameter threshold value. The model creation system then sets one or more machine-learning parameters and hyperparameters of the machine-learning model to be equal to the machine-learning parameters and hyperparameters of the selected tuning step.

Because tuning the machine-learning model to decrease its impact on the system performance metrics on a certain deployment system is likely to decrease the accuracy of the machine-learning model, the model creation system is configured to again modify the machine-learning model such that the machine-learning model has an accuracy equal to or greater than an accuracy loss threshold. In this way, the model creation system allows for a balance between accuracy and the impact on system performance metrics of a deployment system when tuning the machine-learning model. That is, the model creation system is configured to reduce the impact of system performance metrics impact on a deployment system while still maintaining a predetermined accuracy (e.g., based on the accuracy loss threshold) for the machine-learning model. After again modifying the accuracy of the machine-learning model, the model creation system then further modifies the trained machine-learning models so as to reduce the impact of the trained machine-learning model on one or more system performance metrics of the deployment system as described above. The model creation system continues in this way until it is not possible to modify the trained machine-learning model to meet the predetermined threshold accuracy, to reduce the impact the trained machine-learning model has on one or more system performance metrics of the deployment system by a predetermined amount, or both. Once the model creation system stops modifying the trained machine-learning model, the model creation system then distributes the modified machine-learning model to one or more deployments systems via, for example, a network (e.g., local area network, wide area network, data fabric network).

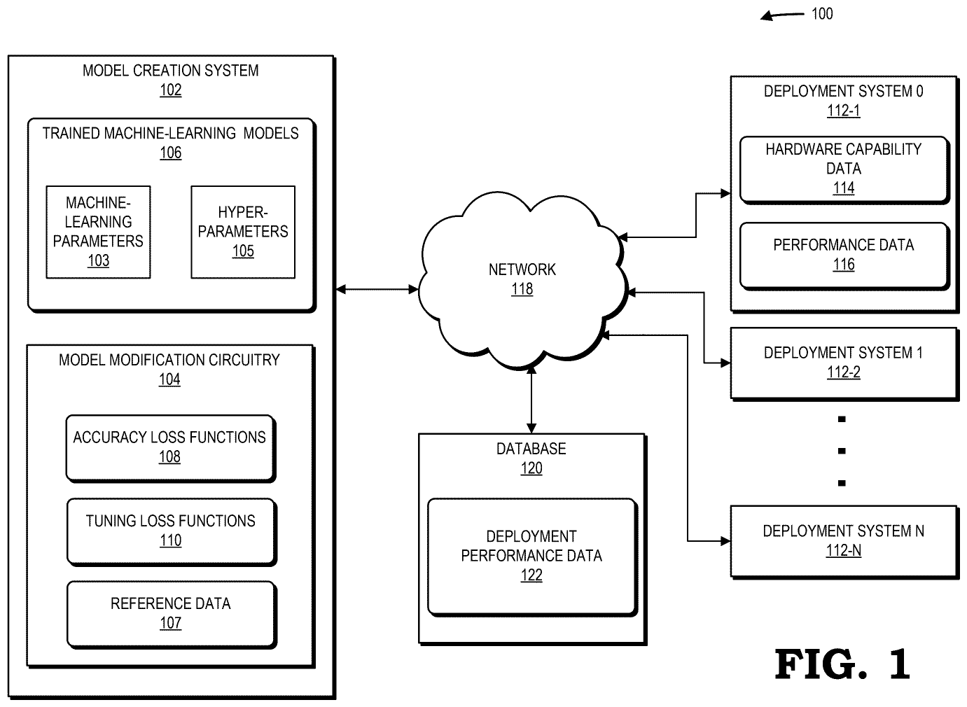

Referring now to FIG. 1, machine-learning model tuning system 100 configured to distribute and modify a trained machine-learning model based on system performance metrics of a deployment system is presented, in accordance with some implementations. According to implementations, machine-learning model tuning system 100 is configured to generate, modify, and distribute one or more machine-learning models (e.g., trained machine-learning models 106) to one or more deployment systems 112. Such machine-learning models generated, modified, and distributed by machine-learning model tuning system 100 include, for example, supervised learning models, semi-supervised learning models, unsupervised learning models, reinforcement learning models, or any combination thereof. As an example, a machine-learning model a Naïve Bayes Classifier model, K-means clustering model, support vector machine model, linear regression model, logistic regression model, artificial neural network, convolutional neural network, recurrent neural network, deep-learning model, large language model, or any combination thereof. To generate, modify, and distribute these machine-learning models, machine-learning model tuning system 100 includes model creation system 102 that includes one or more servers, computers, laptops, processors, processor cores, compute units, programmable logic devices, and the like. For example, in some implementations, model creation system 102 includes one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof configured to generate, modify, and distribute one or more machine-learning models.

According to implementations, model creation system 102 is configured to train one or more machine-learning models using corresponding sets of training data (not shown for clarity) so as to produce one or more trained machine-learning models 106. Such training data, for example, indicates one or more patterns, relations, structures, or any combination thereof that dictate the behavior (e.g., the analysis and inferences) of a machine-learning model. As an example, a trained machine-learning model 106 includes one or more layers together configured to generate one or more outputs based on one or more received inputs according to the patterns, relations, structures, or any combination thereof indicated in a corresponding set of training data. Additionally, based on the training data, a trained machine-learning model 106 is configured to generate one or more outputs from one or more inputs based on one or more machine-learning parameters 103 and one or more hyperparameters 105. For example, one or more layers of a trained machine-learning model 106 are each configured to generate one or more outputs from one or more inputs based on corresponding machine-learning parameters 103 and hyperparameters 105. These machine-learning parameters 103, for example, represent the weights and coefficients used by a trained machine-learning model 106 (e.g., one or more layers of the trained machine-learning model 106) to determine one or more outputs from one or more inputs. Additionally, the hyperparameters 105 represent one or more features of the trained machine-learning model 106 such as data types used (e.g., single-precision FP format, double-precision FP format), matrix dimensions for matrix multiplication, sparsity of matrices for matrix multiplication, dimensions of feature spaces, numbers of branches, learning rates, numbers of layers, numbers of nodes per layer, numbers of connections between layers, epochs, channels of a deployment system 112 used in operations, convolution filter sizes, numbers of weights, or any combination thereof, to name a few.

In implementations, model creation system 102 is configured to distribute one or more trained machine-learning models 106 to one or more deployment systems 112 via a network 118. Network 118, for example, includes a local are network, wide area network, data fabric network, the Internet, or any combination thereof and is configured to communicatively couple one or more deployment systems 112 each to model creation system 102. Each deployment system 112, for example, includes one or more servers, computers, laptops, processors, processor cores, compute units, programmable logic devices, and the like configured to implement one or more trained machine-learning models 106. For example, in some implementations, a deployment system 112 includes one or more vector processors, coprocessors, GPUs, GPGPUs, non-scalar processors, highly parallel processors, AI processors, inference engines, machine-learning processors, other multithreaded processing units, scalar processors, serial processors, programmable logic devices (e.g., FPGAs), or any combination thereof configured to implement one or more trained machine-learning models 106 so as to generate one or more outputs. Further, to implement one or more trained machine-learning models 106, each deployment system 112 includes a memory, caches, or the like configured to store data used in and resulting from the use of a trained machine-learning model 106 by the deployment system 112. Though the example implementation presented in FIG. 1 shows, within machine-learning model tuning system 100, model creation system 102 distributing trained machine-learning models 106 to three deployment systems (112-1, 112-2, 112-N) representing an N number of deployment systems 112, in other implementations, model creation system 102 is configured to distribute any number of trained machine-learning models 106 to any number of deployment systems 112.

According to implementations, after receiving a trained machine-learning model 106 from model creation system 102, a deployment system 112 is configured to implement the trained machine-learning model 106 such that the deployment system 112 uses the trained machine-learning model 106 to generate one or more outputs based on one or more inputs. For example, the deployment system 112 performs one or more instructions, operations, or both as indicated by the trained machine-learning model 106 so as to produce one or more outputs. According to some implementations, after a deployment system 112 determines one or more outputs using a trained machine-learning model 106, the deployment system 112 is configured to store performance data 116 in a memory of the deployment system 112. Such performance data 116, for example, represents the impact executing the trained machine-learning model 106 has on one or more system performance metrics of the deployment system 112 such as power consumed, processing time, processing efficiency, or any combination thereof.

Additionally, according to some implementations, one or more deployment systems 112 are configured to transmit such performance data 116, hardware capability data 114, or both to a database 120 communicatively coupled to the deployment system and model creation system 102 via network 118. Such hardware capability data 114, for example, indicates the amount of memory, number of processors, number of processor cores, number of compute units, clock frequencies, number of caches, cache sizes, bus speeds, and the like of the deployment system 112. Further, the database 120 includes one or more servers, computers, processors, memories, and the like configured to store data such that the data is able to be queried by, for example, model creation system 102. Based on receiving performance data 116, hardware capability data 114, or both from a respective deployment system 112, database 120 associates the performance data 116 with the deployment system 112, the hardware capability data 114 of the deployment system 112 and stores the performance data 116 associated with the deployment system, hardware capability data 114, or both as deployment performance data 122. The deployment performance data 122, for example, includes performance data 116 associated with one or more deployment systems 112, hardware capability data 114 of one or more deployment systems 112, or both that is able to be queried by model creation system 102.

To help reduce the power consumed, the time taken, or both by a deployment system 112 using a trained machine-learning model 106 to generate one or more outputs, model creation system 102 is configured to modify a trained machine-learning model 106 before distributing the trained machine-learning model 106 to a corresponding deployment system 112. To this end, model creation system 102 includes a model modification circuitry 104 configured to modify one or more machine-learning parameters 103, hyperparameters 105, or both of a trained machine-learning model 106 so as to reduce the power consumed, the time taken, or both by a deployment system 112 implementing the trained machine-learning model 106. For example, model creation system 102 is configured to modify one or more machine-learning parameters 103, hyperparameters 105, or both of a trained machine-learning model 106 to modify one or more data types (e.g., single-precision FP format, double-precision FP format), matrix dimensions for matrix multiplication, sparsity of matrices for matrix multiplication, dimensions of feature spaces, numbers of branches, learning rates, numbers of layers, numbers of nodes per layer, numbers of connections between layers, epochs, channels of a deployment system 112 used in operations, convolution filter sizes, numbers of weights, or any combination thereof of the trained machine-learning model 106 such that the power consumed, the time taken, or both by a corresponding deployment system 112 using the trained machine-learning model 106 is reduced.

To help ensure the accuracy of the trained-machine learning model 106 before modifying the trained machine-learning model 106 to reduce its impact on the power consumed, the time taken, or both on a corresponding deployment system 112, model modification circuitry 104 is configured to first modify one or more machine-learning parameters 103, hyperparameters 105, or both of a trained machine-learning model 106 such that an accuracy of the trained machine-learning model 106 is equal to or above a predetermined accuracy threshold. To modify one or more machine-learning parameters 103, hyperparameters 105, or both of a trained machine-learning model 106 such that an accuracy of the trained machine-learning model 106 is equal to or above a predetermined accuracy threshold, model modification circuitry 104 is configured to generate an accuracy loss function 108 for the trained machine-learning model 106 based on a set of reference data 107. This reference data 107, for example, includes sets of inputs for the trained machine-learning model 106 and corresponding outputs (e.g., ground truth outputs) that represent the desired outputs of the trained machine-learning model. For example, in implementations, model modification circuitry 104, based on reference data 107, generates an accuracy loss function 108 indicating an accuracy loss value of the trained machine-learning model 106 as a function of one or more machine-learning parameters 103, hyperparameters 105, or both of the trained machine-learning model 106. This accuracy loss value, for example, represents a degree of difference between an output (e.g., predicted output) generated by the trained machine-learning model 106 from an input and a desired output associated with the same input indicated in the reference data 107. Using the accuracy loss function 108, the model tuning system then determines a set of machine-learning parameters 103, hyperparameters 105, or both that causes the accuracy loss value of the accuracy loss function 108 to be equal to or less than a predetermined accuracy threshold (not shown for clarity) and modifies the trained machine-learning model 106 to include the determined set of machine-learning parameters 103, hyperparameters 105, or both. In this way, the model modification circuitry 104 determines a set of machine-learning parameters 103, hyperparameters 105, or both that causes the accuracy of the trained machine-learning model 106 to be equal to or above a predetermined accuracy threshold by reducing the accuracy loss value of the accuracy loss function 108 determined for the trained machine-learning model 106.

After modifying one or more machine-learning parameters 103, hyperparameters 105, or both of a trained machine-learning model 106 such that the accuracy of the trained machine-learning model 106 is equal to or above a predetermined accuracy threshold, the model modification circuitry 104 modifies one or more machine-learning parameters 103, hyperparameters 105, or both of the trained machine-learning model 106 so as to help reduce the power consumed, the time taken, or both by a deployment system 112 using a trained machine-learning model 106 to generate one or more outputs. For example, the model modification circuitry 104 first generates one or more tuning loss functions 110 each indicating the impact of the trained machine-learning model 106 on a corresponding system performance metric (e.g., power consumption, processing time, processing efficiency) of a certain deployment system 112 as a function of one or more machine-learning parameters 103, hyperparameters 105, or both of the trained machine-learning model 106. As an example, the model modification circuitry 104 generates a computation power loss function indicating a value (e.g., power loss value) representing the power consumed by a certain deployment system 112 using the trained machine-learning model 106 to generate an output as a function of one or more machine-learning parameters 103, hyperparameters 105, or both. As another example, the model modification circuitry 104 generates an execution time loss function indicating a value (e.g., time loss value) representing the time needed by a certain deployment system 112 using the trained machine-learning model 106 to generate an output as a function of the machine-learning parameters 103, hyperparameters 105, or both.

According to implementations, the model modification circuitry 104 is configured to generate one or more tuning loss functions 110 based on the performance data 116 of a corresponding deployment system 112. That is to say, based on data indicating the performance times, power consumption, or both of the deployment system 112 when generating outputs using the trained machine-learning model 106. To obtain such performance data 116, in some implementations, the model modification circuitry 104 is configured to perform one or more simulations of the deployment system 112 generating outputs using the trained machine-learning model 106. To this end, the model modification circuitry 104 is configured first to determine the hardware capability data 114 of the deployment system 112 that will implement the trained machine-learning model 106 by querying database 120 or the deployment system 112. Based on hardware capability data 114, the model modification circuitry 104 performs one or more simulations of the trained machine-learning model 106 as implemented by the amount of memory, number of processors, number of processor cores, number of compute units, clock frequencies, number of caches, cache sizes, bus speeds, or any combination thereof indicated in the hardware capability data 114 to generate performance data 116.

As another example, to obtain performance data 116, the model modification circuitry 104 requests such performance data 116 from the deployment system 112 to which the trained machine-learning model 106 will be distributed. For example, in some implementations, the model modification circuitry 104 sends at least a portion (e.g., pipelines, subgraphs) of the trained machine-learning model 106 to the deployment system 112. The deployment system 112 then executes this portion of the trained machine-learning model 106 to determine performance data 116 which is then transmitted to the model creation system 102. As yet another example, to obtain performance data 116, the model modification circuitry 104 queries database 120 for performance data 116 associated with the deployment system 112 to which the trained machine-learning model 106 will be distributed, performance data 116 associated with the same or similar hardware capability data 114 as the deployment system 112 to which the trained machine-learning model 106 will be distributed, or both.

After obtaining the performance data 116 for a deployment system 112 and identifying one or more tuning loss functions 110 from the performance data 116, the model modification circuitry 104 then determines a total loss function indicating a total loss value based on the accuracy loss function 108 and tuning loss functions 110. For example, the model modification circuitry 104 first applies corresponding weights to the accuracy loss function 108 and each tuning loss function 110. The model modification circuitry 104 then adds together the weighted accuracy loss function 108 and weighted tuning loss functions 110 to generate the total loss function. As an example, in some implementations, the model modification circuitry 104 generates a total loss function for a trained machine-learning model 106 represented as:

$$T ( w ) = L ( w ) + m * T ( w ) + n * E ( w ) \qquad [ EQ 01 ]$$

Wherein T represents a total loss value, L represents the accuracy loss function 108, T represents a computation power loss function indicating a power loss value representing the power consumed by a deployment system 112 implementing the trained machine-learning model 106, E represents an execution time loss function indicating a time loss value representing the time needed by a deployment system 112 implementing the trained machine-learning model 106, m represents a predetermined first weight, n represents a predetermined second weight, and w represents a set of one or more machine-learning parameters 103, hyperparameters 105, or both of the trained machine-learning model 106.

A person or ordinary of skill in the art will understand that, regarding EQ1, the predetermined weights m and n reflect, for example, a predetermined user input that indicates acceptable tradeoffs between accuracy, power consumption, and execution speed. For example, within EQ1, a higher value of m penalizes more increased power consumption relative to accuracy loss, and a higher value of n penalizes increased execution speed relative accuracy loss. In implementations, predetermined weights m and n are determined as a function of a training epoch of the trained machine-learning model 106. For example, in initial epochs of trained machine-learning model 106, a relationship between predetermined weights m an n (e.g., a relationship between the values of m and n) represents a preference of improving accuracy of trained machine-learning model 106 over improving the impact on execution speed and power consumption. As another example, in later epochs of trained machine-learning model 106 (e.g., epochs after the initial epoch), the relationship between predetermined weights m and n indicate a preference to improve the power consumption and execution speed of a deployment system 112 over the accuracy of the trained machine-learning model 106.

Based on the total loss function, the model modification circuitry 104 then determines one or more tuning steps that reduce one or more performance metrics (e.g., power consumed, processing time, processing efficiency) indicated by the total loss function. Each tuning step, for example, represents a corresponding set of one or more machine-learning parameters 103, hyperparameters 105, or both. As an example, the model modification circuitry 104 determines one or more sets of machine-learning parameters 103, hyperparameters 105, or both (e.g., tuning steps) that each reduces the power consumption, elapsed time, or both indicated by the total loss function. That is, one or more sets of machine-learning parameters 103, hyperparameters 105, or both that each indicate one or more respective data types, respective matrix dimensions, respective sparsities, respective dimensions of feature spaces, respective numbers of branches, learning rates, respective numbers of layers, respective numbers of nodes per layer, respective numbers of connections between layers, respective epochs, respective channels of a deployment system 112, respective convolution filter sizes, respective numbers of weights, or any combination thereof that reduce the power consumption, elapsed time, or both indicated by the total loss function. After determining such tuning steps, the model modification circuitry 104 determines a corresponding accuracy loss sensitivity value for each tuning step. Such an accuracy loss sensitivity value, for example, indicates a rate of change for the accuracy loss value of the accuracy loss function 108 as a function of one or more machine-learning parameters 103, hyperparameters 105, or both of the trained machine-learning model 106. As an example, based on the accuracy loss function 108 for the trained machine-learning model 106, the model modification circuitry 104 determines an accuracy loss sensitivity function that indicates an accuracy loss sensitivity value as a function of one or more machine-learning parameters, hyperparameters, or both. In implementations, for example, the model modification circuitry 104 determines a first derivative of the accuracy loss function 108 so as to determine the accuracy loss sensitivity function. Using the accuracy loss sensitivity function, the model modification circuitry 104 then determines a corresponding accuracy loss sensitivity value for each determined tuning step.

Once the model modification circuitry 104 has determined an accuracy loss sensitivity value for each tuning step, the model modification circuitry 104 selects a tuning step based on the accuracy loss sensitivity values. For example, the model modification circuitry 104 selects the tuning step with the lowest accuracy loss sensitivity value (e.g., indicating that the tuning step has the least impact on the accuracy of the trained machine-learning model 106). As another example, the model modification circuitry 104 selects one or more tuning steps based on a hyperparameter threshold. Such a hyperparameter threshold, for example, represents a predetermined value for one or more hyperparameters associated with the trained machine-learning model 106 such as, for example, data formats, matrix dimensions for multiplication operations, sparsity of matrices, numbers of features, number of layers, number of nodes, and the like. For example, the model modification circuitry 104 first determines one or more tuning steps each having a corresponding accuracy loss sensitivity value equal to or less than a predetermined accuracy loss sensitivity threshold. From these tuning steps each having a corresponding accuracy loss sensitivity value equal to or less than a predetermined accuracy loss sensitivity threshold, the model modification circuitry 104 then selects the tuning step indicating a hyperparameter 105 closest in value to a data type, matrix dimension, or sparsity indicated by the hyperparameter threshold.

After selecting a tuning step, the model modification circuitry 104 modifies the trained machine-learning model 106 such that the trained machine-learning model 106 has one or more of the machine-learning parameters 103, hyperparameters 105, or both indicated in the selected tuning step (e.g., selected set of machine-learning parameters 103 and hyperparameters 105). In some implementations, after modifying the model modification circuitry 104 based on the selected tuning step, model modification circuitry 104 then transmits the modified trained machine-learning model 106 to the corresponding deployment system 112. Further, in other implementations, after modifying the model modification circuitry 104 based on the selected tuning step, model modification circuitry 104 again modifies the trained machine-learning model 106 using the accuracy loss function 108 such that the accuracy of the trained machine-learning model 106 is equal to or above a threshold accuracy (e.g., such that the accuracy loss value of the accuracy loss function 108 is equal to or below a threshold value). The model modification circuitry 104 then again modifies the trained machine-learning model 106 by determining tuning steps based on the total loss function and selecting a tuning step based on corresponding accuracy loss sensitivity values. The model modification circuitry 104 continues in this manner until it is not possible to modify the trained machine-learning model 106 to meet the threshold accuracy, to reduce the impact of the trained machine-learning model 106 on one or more system performance metrics by a predetermined amount, or both. After this, the model modification circuitry 104 transmits the modified trained machine-learning model 106 to the corresponding deployment systems 112. In this way, the machine-learning model tuning system 100 is configured to modify a trained machine-learning model 106 based on the hardware capabilities of certain deployment systems 112 so as to reduce the impact on certain system performance metrics of the deployment systems 112 when implementing the trained machine-learning model 106. Additionally, because the machine-learning model tuning system 100 helps ensure that the modified trained machine-learning model 106 still has an accuracy equal to or greater than an accuracy threshold, the impact on the system performance metrics of the deployment system 112 is reduced without a substantial reduction to the accuracy of the trained machine-learning model 106.

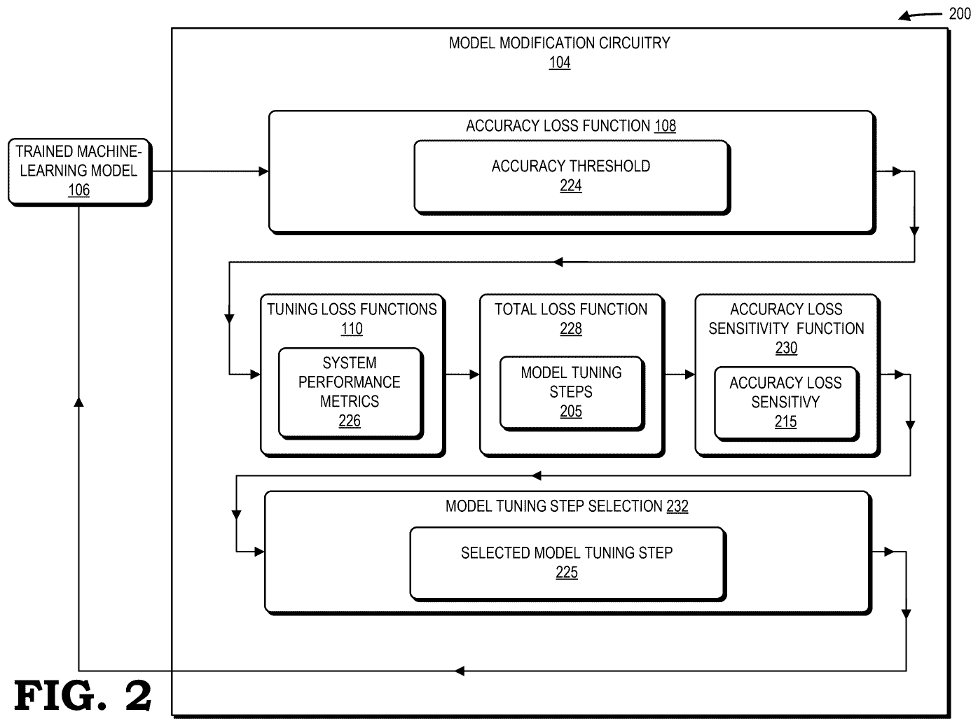

Referring now to FIG. 2, an example operation 200 for modifying a trained machine-learning model based on system performance metrics of a deployment system is presented, in accordance with some implementations. According to implementations, example operation 200 is implemented within machine-learning model tuning system 100 by model modification circuitry 104. In implementations, example operation 200 first includes model modification circuitry 104 generating a corresponding accuracy loss function 108 for a trained machine-learning model 106. This corresponding accuracy loss function 108 indicates an accuracy loss value for the trained machine-learning model 106 as a function of one or more machine-learning parameters 103, hyperparameters 105, or both of the trained machine-learning model 106. To produce such an accuracy loss function 108, model modification circuitry 104 first provides a set of inputs indicated in reference data 107 (e.g., data indicating the desired outputs for the trained machine-learning model 106) to the trained machine-learning model 106 to determine a corresponding set of predicted outputs. The model modification circuitry 104 then modifies one or more machine-learning parameters 103, hyperparameters 105, or both of the trained machine-learning model 106 and again provides the set of inputs indicated in reference data 107 to determine a corresponding second set of predicted outputs. According to implementations, the model modification circuitry 104 then continues modifying the more machine-learning parameters 103, hyperparameters 105, or both and generating corresponding sets of predicted outputs until a predetermined number of sets of predicted outputs is determined. After generating one or more sets of predicted outputs, the model modification circuitry 104 compares the sets of predicted outputs to one or more desired outputs indicated in reference data 107 associated with the same inputs used to generate the sets of predicted outputs. Based on this comparison, the model modification circuitry 104 produces the accuracy loss function 108 such that the accuracy loss function 108 represents an accuracy loss value as a function of machine-learning parameters 103, hyperparameters 105, or both of the trained machine-learning model 106.

Once the model modification circuitry 104 has determined the accuracy loss function 108 for the trained machine-learning model 106, the model modification circuitry 104 determines a set of machine-learning parameters 103, hyperparameters 105, or both that cause the accuracy loss value indicated by the accuracy loss function 108 to be equal to or less than a predetermined accuracy threshold 224. This predetermined accuracy threshold 224, for example, includes a value indicating a threshold accuracy for one or more trained machine-learning models 106. In some implementations, the model modification circuitry 104 determines a set of machine-learning parameters 103, hyperparameters 105, or both that causes the accuracy loss value indicated by the accuracy loss function 108 to be equal to the accuracy threshold 224.

After determining this set of machine-learning parameters 103, hyperparameters 105, or both based on accuracy threshold 224, the model modification circuitry 104 determines one or more tuning loss functions 110 each indicating the impact the trained machine-learning model 106 has on one or more system performance metrics 226 of a deployment system 112 configured to implement the trained machine-learning model 106. As an example, each tuning loss function indicates a value representing the impact the trained machine-learning model 106 has on one or more certain system performance metrics 226 as a function of one or more machine-learning parameters 103, hyperparameters 105, or both of the trained machine-learning model 106. These system performance metrics 226 include, for example, the power consumption by a certain deployment system 112 using the trained machine-learning model 106 to determine outputs, the processing time of a certain deployment system using the trained machine-learning model 106 to determine outputs, the power efficiency of a deployment system 112 using the trained machine-learning model 106 to determine outputs, or any combination thereof. In implementations, to determine a tuning loss function 110, the model modification circuitry 104 is configured to use performance data 116 of the deployment system 112 on which the trained machine-learning model 106 is to be implemented. This performance data 116, as an example, represents one or more system performance metrics 226 of the corresponding deployment system 112 when the deployment system 112 used the trained machine-learning model 106 with one or more sets of machine-learning parameters and hyperparameters 105 to generate one or more outputs.

According to implementations, the model modification circuitry 104 is configured to obtain performance data 116 for a corresponding deployment system 112 by performing one or more simulations, querying database 120, transmitting data to the deployment system 112, or any combination thereof. As an example, the model modification circuitry 104 first obtains the hardware capability data 114 of the deployment system 112 by querying database 120 or the deployment system 112. The model modification circuitry 104 then performs one or more simulations of the trained machine-learning model 106 as implemented by the amount of memory, number of processors, number of processor cores, number of compute units, clock frequencies, number of caches, cache sizes, bus speeds, or any combination thereof indicated in the hardware capability data 114 to generate performance data 116. As another example, the model modification circuitry 104 queries database 120 for any deployment performance data 122 associated with a corresponding deployment system 112 (e.g., deployment performance data 122 received from the corresponding deployment system 112). Based on the query, the model modification circuitry 104 then receives performance data 116 associated with the deployment system 112. As yet another example, the model modification circuitry 104, via network 118, transmits data representing at least a portion (e.g., pipelines, subgraphs) of the trained machine-learning model 106 with one or more sets of machine-learning parameters 103 and hyperparameters 105 to the corresponding deployment system 112. Based on receiving data representing this portion of the trained machine-learning model 106, the deployment system 112 performs the portion of the trained machine-learning model 106 (e.g., one or more subgraphs or pipelines of the trained machine-learning model 106) so as to determine performance data 116. The deployment system 112 then transmits the determined performance data 116 to the model modification circuitry 104 via network 118.

Using the performance data 116 associated with a corresponding deployment system 112, the model modification circuitry 104 determines one or more tuning loss functions 110. As an example, based on performance data 116 associated with a corresponding deployment system 112, the model modification circuitry 104 determines a corresponding system performance metric 226 (e.g., power consumption, processing time, processing efficiency) for each set of machine-learning parameters 103 and hyperparameters 105 indicated in the performance data 116. The model modification circuitry 104 then generates one or more tuning loss functions each indicating the impact (e.g., additional power consumption, additional processing time, decrease in processing efficiency) the trained machine-learning model 106 has on a certain system performance metric 226 as a function of machine-learning parameters 103, hyperparameters 105, or both of the trained machine-learning model 106. For example, the model modification circuitry 104 generates a computation power loss function indicating a value (e.g., power loss value) representing the additional power consumed by the deployment system 112 when using the trained machine-learning model 106 as a function of one or more machine-learning parameters 103, hyperparameters 105, or both and an execution time loss function indicating a value (e.g., time loss value) representing the time needed by the deployment system 112 to the trained machine-learning model 106 to generate an output as a function of the machine-learning parameters 103, hyperparameters 105, or both.

After generating one or more tuning loss functions 110, example operation 200 further includes the model modification circuitry 104 generating a total loss function 228 based on the accuracy loss function 108 and the determined tuning loss functions 110. As an example, the model modification circuitry 104 first applies a predetermined corresponding weight to the accuracy loss function 108 and each of the determined tuning loss functions 110 and adds the weighted accuracy loss function 108 and weighted tuning loss functions 110 to produce the total loss function 228. This total loss function 228, for example, indicates a total loss value as a function of one or more machine-learning parameters 103, hyperparameters 105, or both of the trained machine-learning model 106. Further, example operation 200 includes the model modification circuitry 104 determining one or more model tuning steps 205 based on the determined total loss function 228. Each of these model tuning steps 205 represents a set of one or more machine-learning parameters 103, hyperparameters 105, or both that reduce the impact of the trained machine-learning model 106 on one or more system performance metrics 226 of the deployment system 112 implementing the trained machine-learning model 106. To determine a model tuning step 205, the model modification circuitry 104, using the total loss function 228, determines one or more machine-learning parameters 103, hyperparameters 105, or both that reduce the loss indicated by one or more weighted tuning loss functions 110 of the total loss function 228. That is to say, as an example, the model modification circuitry 104 determines one or more machine-learning parameters 103, hyperparameters 105, or both that reduce the impact the trained machine-learning model 106 has on the power consumption, processing time, processing efficiency, or any combination thereof of the deployment system 112 implementing the trained machine-learning model 106.

According to implementations, example operation 200 also includes the model modification circuitry 104 generating an accuracy loss sensitivity function 230 that indicates a value (e.g., accuracy loss sensitivity 215) representing a rate of change for the accuracy loss value of the accuracy loss function 108 as a function of one or more machine-learning parameters 103, hyperparameters 105, or both of the trained machine-learning models 106. To generate such an accuracy loss sensitivity function 230, the model modification circuitry 104 performs one or more operations to determine the first derivative of the accuracy loss function 108. Using the accuracy loss sensitivity function 230, the model modification circuitry 104 then determines a corresponding accuracy loss sensitivity 215 for each determined model tuning step 205. For example, the model modification circuitry 104 determines the accuracy loss sensitivity 215 represented by the accuracy loss sensitivity function 230 for the machine-learning parameters 103, hyperparameters 105, or both indicated in a respective model tuning step 205 to determine the accuracy loss sensitivity 215 for the model tuning step 205.

Once the model modification circuitry 104 has determined a corresponding accuracy loss sensitivity 215 for each determined model tuning step 205, the example operation 200 includes the model modification circuitry 104 performing a model tuning step selection 232. During the model tuning step selection 232, the model modification circuitry 104 selects one or more of the determined model tuning steps 205 based on their corresponding accuracy loss sensitivities 215. For example, the model modification circuitry 104 selects the model tuning step 205 having the lowest accuracy loss sensitivity 215 so as to produce a selected model tuning step 225 that has the least amount of impact on the accuracy of the trained machine-learning model 106. As another example, the model modification circuitry 104 selects the model tuning step 225 having an accuracy loss sensitivity 215 closest in value to a predetermined accuracy loss sensitivity threshold to produce a selected model tuning step 225. As yet another example, the model modification circuitry 104 first selects a predetermined number of model tuning steps 205 having accuracy loss sensitivities 215 lowest in value. From this predetermined number of model tuning steps 205, the model modification circuitry then selects the model tuning step 205 representing a hyperparameter 105 closest in value to a predetermined hyperparameter threshold to produce a selected model tuning step 225. This predetermined hyperparameter threshold includes, for example, values representing predetermined hyperparameters 105 such as data formats (e.g., single-precision floating point format, double-precision floating point format), matrix dimensions for matrix multiplication, numbers of branches, learning rates, numbers of layers, numbers of nodes per layer, numbers of connections between layers, sparsity of matrices, epochs, or any combination thereof.

According to implementations, after the model modification circuitry 104 has determined a selected model tuning step 225, example operation 200 includes the model modification circuitry 104 modifying the trained machine-learning model 106 based on the selected model tuning step 225. For example, the model modification circuitry 104 modifies one or more machine-learning parameters 103, hyperparameters 105, or both of the trained machine-learning model 106 such that the trained machine-learning model 106 includes the machine-learning parameters 103, hyperparameters 105, or both of the selected model tuning step 225 (e.g., the model tuning step 205 selected by the model modification circuitry 104). In implementations, once model modification circuitry 104 has modified the trained machine-learning model 106, the model modification circuitry 104 then repeats example operation 200 using the modified trained machine-learning model 106. For example, the model modification circuitry 104 first determines one or more machine-learning parameters 103, hyperparameters 105, or both that cause the accuracy loss value indicated by an accuracy loss function 108 to be equal to or less than the accuracy threshold 224. The model modification circuitry 104 then determines one or more model tuning steps 205 that reduce the impact of the modified trained machine-learning model 106 on one or more system performance metrics 226 of a deployment system 112 implementing the modified trained machine-learning model 106 as discussed above. Further as discussed above, the model modification circuitry 104 selects one of the determined model tuning steps 205 to produce a selected model tuning step 225 that the model modification circuitry 104 then uses to modify the modified trained machine-learning model 106. The model modification circuitry 104 continues performing example operation 200 in this manner until it is not possible to further modify the trained machine-learning model 106 (e.g., modified trained model) so that the accuracy less value represented by the accuracy loss function 108 is equal to or below the accuracy threshold 224, it is not possible to further modify the trained machine-learning model 106 so as to reduce the impact of the trained machine-learning model 106 on one or more system performance metrics 226 by a predetermined amount, or both.

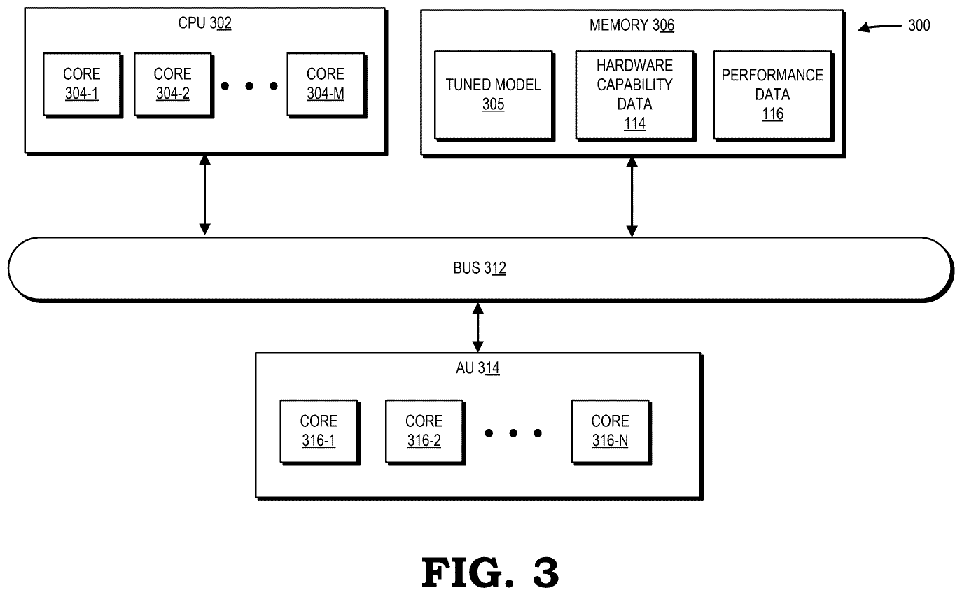

Referring now to FIG. 3, an example deployment system 300 configured to implement a trained machine-learning model modified based on system performance parameters is presented, in accordance with some implementations. In implementations, example deployment system 300 is represented in machine-learning model tuning system 100 as one or more deployment systems 112. According to implementations, example deployment system 112 is implemented within one or more servers, databases, cloud-based devices, personal computers, laptops, drones, mobile devices, or the like and includes or has access to memory 306 or other storage components implemented using a non-transitory computer-readable medium, for example, a dynamic random-access memory (DRAM). In some implementations, memory 306 is implemented using other types of memory including, for example, static random-access memory (SRAM), nonvolatile RAM, and the like. Further, memory 306, according to some implementations, includes an external memory to the example deployment system 300. The example deployment system 300 also includes a bus 312 to support communication between one or more components (e.g., central processing unit (CPU) 302, acceleration unit (AU) 314, memory 306) of the example deployment system 300. Some implementations of example deployment system 300 include other buses, bridges, switches, routers, and the like, which are not shown in FIG. 3 in the interest of clarity. For example, in some implementations, example deployment system 300 includes a data fabric that includes bus 312 and that is configured to support communication between one or more components of the example deployment system 300.

In implementations, example deployment system 300 is configured to execute one or more applications stored, for example, in memory 306. For example, example deployment system 300 is configured to execute an application (e.g., compute application, graphics application, databasing application, high-performance computing application) that requires one or more operations to be performed by a trained machine-learning model, trained neural network, or both. To perform these operations, example deployment system 300 is configured to implement a tuned model 305 received from, for example, model creation system 102. As an example, model creation system 102 is configured to modify, using example operation 200, a trained machine-learning model 106 such that the accuracy of the trained machine-learning model 106 is equal to or above a threshold accuracy and such that the impact of the trained machine-learning model 106 on one or more system performance metrics 226 of example deployment system 300 is reduced. Such a modified trained machine-learning model 106 is represented in FIG. 3 as tuned model 305. After producing this tuned model 305, the model creation system 102 transmits, via network 118, the tuned model 305 to the example deployment system 300.

According to implementations, to implement the tuned model 305, example deployment system 300 includes AU 314. AU 314, for example, is configured to operate as one or more vector processors, coprocessors, GPUs, GPGPUs, non-scalar processors, highly parallel processors, AI processors, inference engines, machine-learning processors, other multithreaded processing units, scalar processors, serial processors, programmable logic devices (e.g., FPGAs), or any combination thereof. In implementations, AU 314 performs one or more instructions, operations, or both for the tuned model 305. As an example, AU 314 performs one or more matrix multiplication operations (e.g., matmul operations) to determine values for one or more layers of the tuned model 305. To perform such instructions and operations for tuned model 305, AU 314 implements a plurality of processor cores 316-1, 316-2, 316-N that execute instructions concurrently or in parallel. In some implementations, one or more of the processor cores 316 each operate as one or more compute units (e.g., single instruction, multiple data (SIMD) units) that perform the same operation on different data sets. Though in the example implementation illustrated in FIG. 3, AU 314 includes three processor cores (316-1, 316-2, 316-N) representing an N number of cores, the number of processor cores 316 implemented in AU 314 is a matter of design choice. As such, in other implementations, AU 314 can include any number of processor cores 316. According to implementations, after performing one or more instructions, operations, or both for tuned model 305, each processor core 316 is configured to store the data resulting from the instruction or operation (e.g., results) in memory 306, external storage, or both.

Further, the example deployment system 300 also includes a CPU 302 that is connected to the bus 312 and therefore communicates with the AU 314 and the memory 306 via the bus 312. CPU 302 implements a plurality of processor cores 304-1 to 304-M that execute instructions concurrently or in parallel. In implementations, one or more processor cores 304 of CPU 302 are configured to perform one or more instructions, operations, or both for tuned model 305. As an example, one or more processor cores 304 of CPU 302 are configured to perform one or more matrix multiplication operations. In implementations, these processor cores 304 are configured to store data resulting from these operations in memory 306, external storage, or both. Though in the example implementation illustrated in FIG. 3, three processor cores (304-1, 304-2, 304-M) are presented representing an M number of cores, the number of processor cores 304 implemented in CPU 302 is a matter of design choice. As such, in other implementations, CPU 302 can include any number of processor cores 304. In some implementations, CPU 302 and AU 314 have an equal number of processor cores 304, 316 while in other implementations, CPU 302 and AU 314 have a different number of processor cores 304, 316. According to implementations, CPU 302 is configured to provide data to AU 314 instructing AU 314 to perform one or more instructions, operations, or both for tuned model 305. As an example, CPU 302 is configured to provide instructions to AU 314 indicating one or more matrix multiplication operations to perform for tuned model 305.

In implementations, one or more metrics of the components (e.g., CPU 302, memory 306, AU 314, bus 312) of example deployment system 300 are represented in FIG. 3 as hardware capability data 114 stored in, for example, memory 306. As an example, within the example deployment system 300, hardware capability data 114 represents the number of processor cores 304, processing speed of processor cores 304, number of compute units, number of caches, sizes of caches, bus speed, number of processor cores 316, processing speed of processor cores 316, memory size, clock frequencies, or any combination thereof of CPU 302, memory 306, AU 314, bus 312, or any combination thereof. According to some implementations, example deployment system 300 is configured to transmit such hardware capability data 114 to model creation system 102, database 120, or both via network 118. Additionally, in implementations, based on performing at least a portion of tuned model 305 (e.g., one or more pipelines, one or more subgraphs), example deployment system 300 is configured to generate performance data 116. Within example deployment system 300, such performance data 116 represents the impact implementing tuned model 305 has one or more system performance metrics 226 of the example deployment system 300 such as the power consumed, processing time, processing efficiency, or any combination thereof. After generating such performance data 116, example deployment system 300 is configured to transmit the performance data 116 to model creation system 102, database 120, or both via network 118.

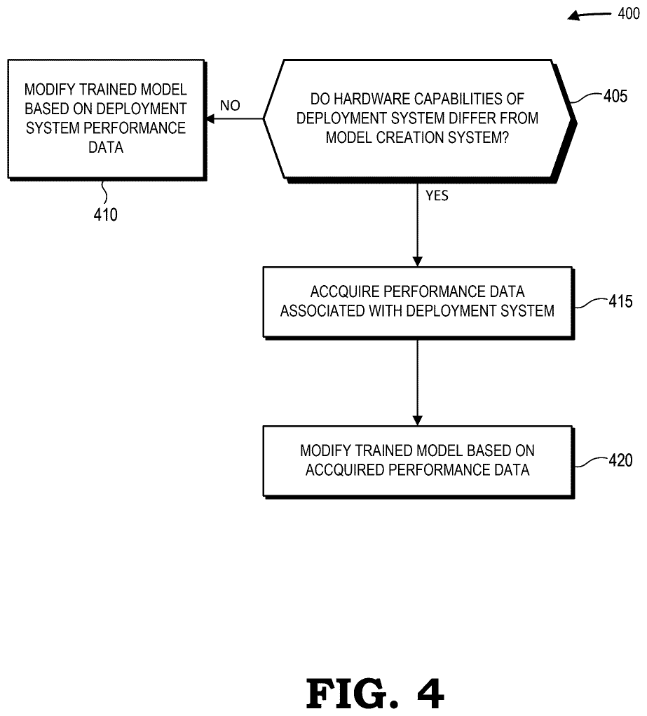

Referring now to FIG. 4, an example method 400 for modifying a trained machine-learning model based on performance data from a deployment system is presented, in accordance with some implementations. In implementations, example method 400 is implemented in machine-learning model tuning system 100 at least in part by model creation system 102. Within example method 400, at block 405, model creation system 102 is configured to modify a trained machine-learning model 106 by first determining whether the hardware capabilities of model creation system 102 differ from the hardware capabilities of a corresponding deployment system 112 on which the trained machine-learning model 106 is to be implemented. That is to say, whether the number of processors, number of processor cores, number of compute units, number of caches, sizes of caches, bus speeds, memory sizes, clock frequencies, or any combination thereof differs between model creation system 102 and the corresponding deployment system 112. To make such a determination, model creation system 102 is configured to first obtain the hardware capability data 114 associated with the corresponding deployment system 112 by querying database 120, requesting the hardware capability data 114 from the deployment system 112, or both. Based on the obtained hardware capability data 114, model creation system 102 then determines whether the number of processors, number of processor cores, number of compute units, number of caches, sizes of caches, bus speeds, memory sizes, clock frequencies, or any combination thereof indicated in the hardware capability data 114 differs from the number of processors, number of processor cores, number of compute units, number of caches, sizes of caches, bus speeds, memory sizes, clock frequencies, or any combination thereof of model creation system 102.

Based on one or more of the number of processors, number of processor cores, number of compute units, number of caches, sizes of caches, bus speeds, memory sizes, clock frequencies, or any combination thereof not differing from the number of processors, number of processor cores, number of compute units, number of caches, sizes of caches, bus speeds, memory sizes, clock frequencies, or any combination thereof of model creation system 102, model creation system 102, at block 410, modifies the trained machine-learning model 106 using, for example, performance data 116 generated by model creation system 102. That is to say, based on the hardware capabilities of the corresponding deployment system 112 not different from the hardware capabilities of model creation system 102, model creation system 102, at block 410, modifies the trained machine-learning model 106 using performance data 116 generated when model creation system 102 implemented at least a portion of the trained machine-learning model 106. As an example, model creation system 102 modifies, using example operation 200, the trained machine-learning model 106 such that the accuracy of the trained machine-learning model 106 is equal to above a threshold accuracy. Further, model creation system 102 modifies the trained machine-learning model 106, based on the performance data 116 generated at model creation system 102, such that the impact of the trained machine-learning model 106 on one or more system performance metrics 226 of model creation system 102 is reduced. Model creation system 102, via network 118, then transmits the modified trained machine-learning model (e.g., tuned model 305) to the corresponding deployment system 112.

Referring again to block 405, based on one or more of the number of processors, number of processor cores, number of compute units, number of caches, sizes of caches, bus speeds, memory sizes, clock frequencies, or any combination thereof differing from the number of processors, number of processor cores, number of compute units, number of caches, sizes of caches, bus speeds, memory sizes, clock frequencies, or any combination thereof of model creation system 102, model creation system 102, at block 415, acquires performance data 116 associated with the deployment system 112. In other words, based on the hardware capabilities of the corresponding deployment system 112 differing from the hardware capabilities of model creation system 102, model creation system 102, at block 415, acquires performance data 116 associated with the deployment system 112. To acquire this performance data 116, model creation system 102 is configured to perform one or more simulation operations, query database 120, transmit at least a portion (e.g., one or more subgraphs) of the trained machine-learning model 106 to the deployment system 112, or any combination thereof.

As an example, still referring to block 415, to acquire performance data 116 for the deployment system 112, model creation system 102 first queries database 120 for hardware capability data 114 associated with the deployment system 112, transmits data requesting hardware capability data 114 from the deployment system 112, or both. Using the hardware capability data 114 of the deployment system 112, model creation system 102 then performs one or more simulation operations to simulate the implementation of at least a portion of (e.g., one or more subgraphs of, one or more pipelines of) trained machine-learning model 106 using the amount of memory, number of processors, number of processor cores, number of compute units, clock frequencies, number of caches, bus speeds, cache sizes, or any combination indicated in the hardware capability data 114. Based on these simulation operations, model creation system 102 then determines performance data 116 representing the impact of the trained machine-learning model 106 on one or more system performance metrics 226 of the deployment system 112. As another example, model creation system 102 queries database 120 for any performance data 116 associated with the corresponding deployment system 112. In response to this query, the database 120 then transmits the performance data 116 associated with the deployment system 112 to model creation system 102. As yet another example, model creation system 102 first transmits data indicating at least a portion of (e.g., one or more subgraphs of, one or more pipelines of) the trained machine-learning model 106 to the corresponding deployment system 112. Based on receiving this data, the deployment system 112 then implements at least a portion of the trained machine-learning model 106 and generates performance data 116 representing the impact of the trained machine-learning model 106 on one or more system performance metrics 226 of the deployment system 112. The deployment system 112 then transmits this performance data 116 back to model creation system 102 via network 118.

After acquiring the performance data 116, at block 420, model creation system 102 modifies the trained machine-learning model 106 based on the acquired performance data 116. As an example, model creation system 102 modifies the trained machine-learning model 106 such that the impact of the trained machine-learning model 106 on one or more system performance metrics 226 of the deployment system 112 is reduced. To this end, in implementations, model creation system 102 first modifies, using example operation 200, the trained machine-learning model 106 such that the accuracy of the trained machine-learning model 106 is equal to above a threshold accuracy. Model creation system 102 then modifies the trained machine-learning model 106, based on the acquired performance data 116, such that the impact of the trained machine-learning model 106 on one or more system performance metrics 226 (e.g., power consumption, processing time, processing efficiency) of the deployment system 112 are reduced. Model creation system 102, via network 118, then transmits the modified trained machine-learning model (e.g., tuned model 305) to the deployment system 112.

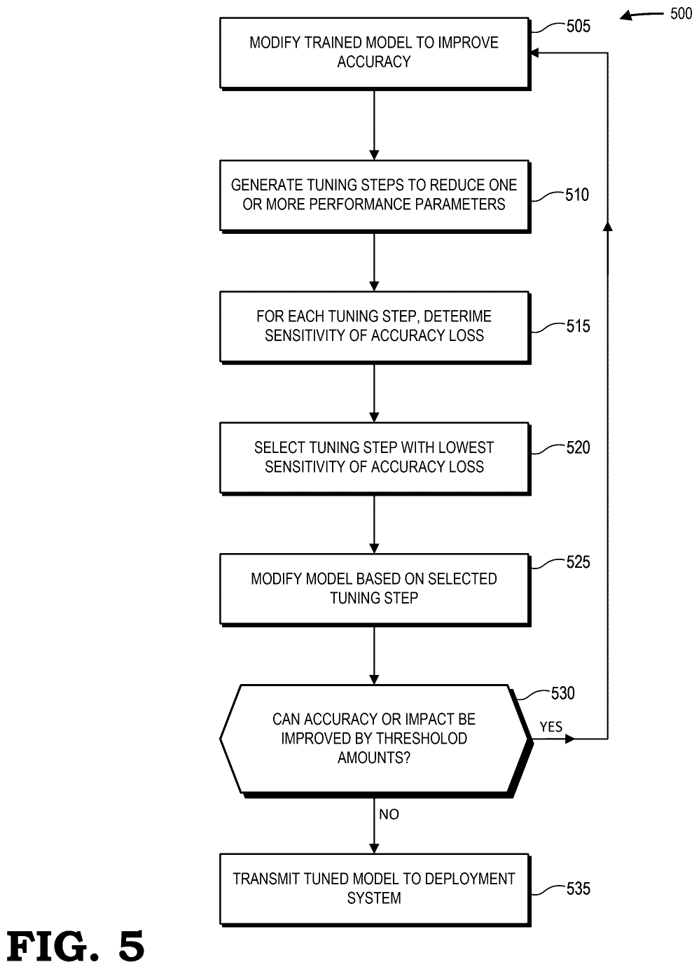

Referring now to FIG. 5, an example method 500 for modifying a trained machine-learning model based on system performance parameters is presented, in accordance with implementations. In implementations, example method 500 is implemented in machine-learning model tuning system 100 at least in part by model creation system 102. Within example method 500, at block 505, model creation system 102 is configured to first modify a trained machine-learning model 106 such that the accuracy of the trained machine-learning model 106 is equal to or above a predetermined accuracy threshold. To this end, based on reference data 107, model creation system 102 first generates an accuracy loss function 108 that indicates an accuracy loss value as a function of one or more machine-learning parameters 103, hyperparameters 105, or both of the trained machine-learning model 106. Model creation system 102 then determines, at 510, different sets of machine-learning parameters 103, hyperparameters 105, or both that cause the accuracy loss function 108 to indicate an accuracy loss value equal to or below an accuracy threshold 224. Model creation system 102 then modifies the trained machine-learning model 106 based on the determined set of machine-learning parameters 103, hyperparameters 105, or both (e.g., model creation system 102 modifies the trained machine-learning model to include the determined set of machine-learning parameters 103 and hyperparameters 105).

After modifying the trained machine-learning model 106 such that the accuracy of the trained machine-learning model 106 is equal to or above a predetermined accuracy threshold, at block 510, model creation system 102 generates one or more model tuning steps 205 each indicating one or more machine-learning parameters 103, hyperparameters 105, or both that reduce the impact of the trained machine-learning model 106 on one or more system performance metrics 226 (e.g., power consumption, processing time, processing efficiency) of a corresponding deployment system 112 (e.g., the deployment system 112 to which the trained machine-learning model 106 is to be implemented). To this end, model creation system 102 first generates one or more tuning loss functions 110 based on performance data 116 associated with a corresponding deployment system 112. According to implementations, model creation system 102 obtains this performance data 116 by performing one or more simulations, querying a database 120, transmitting at least a portion (e.g., one or more subgraphs) of the trained machine-learning model 106 to the deployment system 112, or any combination thereof. Additionally, each of these tuning loss functions 110 indicates the impact of the trained machine-learning model 106 on a corresponding system performance metric (e.g., power consumption, processing time, processing efficiency) of the deployment system 112 as a function of one or more machine-learning parameters 103, hyperparameters 105, or both. Using these tuning loss functions 110 and the accuracy loss function 108, model creation system 102 generates a total loss function 228 by, for example, applying corresponding weights to the accuracy loss function 108 and each tuning loss function 110 and combining the weighted accuracy loss function 108 and weighted tuning loss functions 110. Based on the total loss function 228, model creation system 102 determines one or more model tuning steps 205 that each include a set of one or more machine-learning parameters 103, hyperparameters 105, or both that reduce the impact of the trained machine-learning model 106 on a system performance metric 226 of the deployment system 112.

For each of the determined model tuning steps 205, at step 515, model creation system 102 determines a corresponding accuracy loss sensitivity 215. For example, model creation system 102 determines an accuracy loss sensitivity function 230 by taking a first derivative of the accuracy loss function 108. This accuracy loss sensitivity function 230, for example, indicates an accuracy loss sensitivity 215 as a function of one or more machine-learning parameters 103, hyperparameters 105, or both. Based on this accuracy loss sensitivity function 230, model creation system 102 determines a corresponding accuracy loss sensitivity 215 for each model tuning step 205. At block 520, model creation system 102 then selects the model tuning step 205 having the lowest accuracy loss sensitivity 215. That is to say, model creation system 102 selects the model tuning step 205 having the least impact on the accuracy of the trained machine-learning model 106. After selecting this model tuning step 205, at block 525, model creation system 102 modifies the trained machine-learning model 106 (e.g., as modified at block 505) based on the selected model tuning step 205. As an example, model creation system 102 modifies the trained machine-learning model 106 to include the machine-learning parameters 103, hyperparameters 105, or both indicated in the selected model tuning step 205.

Once the trained machine-learning model 106 has been modified, at block 530, model creation system 102 determines whether the trained machine-learning model (e.g., as modified by block 525) is able to be further modified to improve the accuracy of the trained machine-learning model 106, the impact of the trained machine-learning model 106 on one or more system performance metrics 226 of the corresponding deployment system 112, or both by a predetermined threshold amount. As an example, in implementations, model creation system 102 determines, using accuracy loss function 108, whether one or more machine-learning parameters 103, hyperparameters 105, or both of the trained machine-learning model 106 (e.g., as modified by block 525) are able to be modified to reduce the accuracy loss value by a predetermined threshold amount. Further, as an example, model creation system 102 determines, using total loss function 228, whether one or more machine-learning parameters 103, hyperparameters 105, or both of the trained machine-learning model 106 (e.g., as modified by block 525) are able to be modified to reduce the impact of the trained machine-learning model 106 on one or more system performance metrics 226 of the deployment system 112 by respective predetermined threshold amounts. Based on model creation system 102 determining that the trained machine-learning model (e.g., as modified by block 525) is able to be further modified to improve the accuracy of the trained machine-learning model 106, the impact of the trained machine-learning model 106 on one or more system performance metrics 226 of the corresponding deployment system 112, or both, model creation system 102 repeats block 505 and improves the accuracy of the trained machine-learning model 106. Further, based on model creation system 102 determining that the trained machine-learning model (e.g., as modified by block 525) is not able to be further modified to improve the accuracy of the trained machine-learning model 106, the impact of the trained machine-learning model 106 on one or more system performance metrics 226 of the corresponding deployment system 112, or both, model creation system 102, at block 535, transmits the trained machine-learning model 106 (e.g., as modified by block 525) to the corresponding deployment system 112.

In some implementations, the apparatus and techniques described above are implemented in a system including one or more integrated circuit (IC) devices (also referred to as integrated circuit packages or microchips), such as the model creation system described above with reference to FIGS. 1-5. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A machine-learning model tuning system, comprising:
one or more servers configured to:
select a tuning step from a plurality of tuning steps based on a plurality of accuracy loss sensitivity values, wherein each tuning step of the plurality of tuning steps represents a corresponding set of one or more machine-learning parameters and one or more hyperparameters that reduces an impact of a machine-learning model on one or more system performance metrics of a deployment system;
modify the machine-learning model based on the selected tuning step; and
transmit the modified machine-learning model to the deployment system.

2. The machine-learning model tuning system of claim 1, wherein the one or more servers are configured to:
based on performance data associated with the deployment system and the machine-learning model, determine one or more tuning loss functions each indicating an impact of the machine-learning model on a corresponding system performance metric of the deployment system; and
generate the plurality of tuning steps based on the one or more tuning loss functions.

3. The machine-learning model tuning system of claim 1, wherein the one or more servers are configured to:
modify one or more machine-learning parameters of the modified machine-learning model based on an accuracy threshold; and
generate a second plurality of tuning steps each representing a corresponding set of one or more machine-learning parameters and one or more hyperparameters that reduces an impact of the modified machine-learning model on the one or more system performance metrics of the deployment system.

4. The machine-learning model tuning system of claim 3, wherein the one or more servers are configured to:
select a second tuning step from the second plurality of tuning steps based on a second plurality of accuracy loss sensitivity values; and
modify the modified machine-learning model based on the selected second tuning step.

5. The machine-learning model of claim 1, wherein the one or more servers are configured to:
generate an accuracy loss function based on reference data associated with the machine-learning model; and
determine an accuracy loss sensitivity function based on the accuracy loss function.

6. The machine-learning model of claim 5, wherein the one or more servers are configured to:
generate the plurality of accuracy loss sensitivity values based on the accuracy loss sensitivity function and the plurality of tuning steps.

7. The machine-learning model of claim 1, wherein each corresponding set of one or more machine-learning parameters and one or more hyperparameters indicates a respective data type.

8. A method, comprising:
selecting a tuning step from a plurality of tuning steps based on a plurality of accuracy loss sensitivity values, wherein each tuning step of the plurality of tuning steps represents a corresponding set of one or more machine-learning parameters and one or more hyperparameters that reduces an impact of a machine-learning model on one or more system performance metrics of a deployment system;
modifying the machine-learning model based on the selected tuning step; and
providing the modified machine-learning model to the deployment system.

9. The method of claim 8, further comprising:
based on performance data associated with the deployment system and the machine-learning model, determining one or more tuning loss functions each indicating an impact of the machine-learning model on a corresponding system performance metric of the deployment system; and
generating the plurality of tuning steps based on the one or more tuning loss functions.

10. The method of claim 8, further comprising:
modifying one or more machine-learning parameters of the modified machine-learning model based on an accuracy threshold; and
generating a second plurality of tuning steps each representing a corresponding set of one or more machine-learning parameters and one or more hyperparameters that reduces an impact of the modified machine-learning model on the one or more system performance metrics of the deployment system.

11. The method of claim 10, further comprising:
selecting a second tuning step from the second plurality of tuning steps based on a second plurality of accuracy loss sensitivity values; and
modifying the modified machine-learning model based on the selected second tuning step.

12. The method of claim 8, further comprising:
generating an accuracy loss function based on reference data associated with the machine-learning model; and
determining an accuracy loss sensitivity function based on the accuracy loss function.

13. The method of claim 12, further comprising:
generating the plurality of accuracy loss sensitivity values based on the accuracy loss sensitivity function and the plurality of tuning steps.

14. The method of claim 8, wherein each corresponding set of one or more machine-learning parameters and one or more hyperparameters indicates a respective matrix dimension.

15. A machine-learning model tuning system, comprising:
one or more servers connected to a deployment system by a network, the one or more servers configured to:
based on performance data associated with the deployment system, generate one or more tuning loss functions each indicating an impact of a machine-learning model on one or more system performance metrics of the deployment system;
select a set of machine-learning parameters and hyperparameters based on the one or more tuning loss functions;
modify the machine-learning model based on the set of machine-learning parameters and hyperparameters to produce a modified machine-learning model; and
provide the modified machine-learning model to the deployment system.

16. The machine-learning model tuning system of claim 15, wherein the one or more servers are configured to:
based on hardware capability data associated with the deployment system, perform one or more simulations of at least a portion of the machine-learning model to produce the performance data associated with the deployment system.

17. The machine-learning model tuning system of claim 15, wherein the one or more servers are configured to:
query a database for the performance data associated with the deployment system.

18. The machine-learning model tuning system of claim 15, wherein the one or more servers are configured to:
transmit data representing a least a portion of the machine-learning model to the deployment system; and
receive, from the deployment system, the performance data associated with the deployment system.

19. The machine-learning model tuning system of claim 15, wherein the one or more servers are configured to:
modify one or more machine-learning parameters of the modified machine-learning model based on an accuracy threshold; and
based on the one or more tuning loss functions, generate corresponding sets of machine-learning parameters and hyperparameters that each reduce an impact of the modified machine-learning model on the one or more system performance metrics of the deployment system.

20. The machine-learning model tuning system of claim 19, further comprising:
selecting a second set of machine-learning parameters and hyperparameters from the sets of machine-learning parameters and hyperparameters; and
modifying the modified machine-learning model based on the second set of machine-learning parameters and hyperparameters.
